(19) United States
(12) Patent Application Publication
(10) Pub. No.: US 2012/0287273 A1
(43) Pub. Date: Nov. 15, 2012

(54) SYSTEM FOR IDENTIFYING SUSTAINABLE GEOGRAPHICAL AREAS BY REMOTE SENSING TECHNIQUES AND METHOD THEREOF

(75) Inventors: Ricardo Arjona Antolin, Sevilla (ES); Maria de las Nieves Valenzuela Romero, Sevilla (ES); Beatriz Alonso Martinez, Madrid (ES); Raquel Diaz Molist, Madrid (ES); Rocio Garcia Encinas, Sevilla (ES); Maria Angeles Gutierrez Montero, Sevilla (ES); Jesus Yanez Vidal, Sevilla (ES); Laura Montes Garcia, Sevilla (ES); Jesus Lopez Lopez, Sevilla (ES); Macarena Marquez Piñuela, Sevilla (ES); Marta Vazquez Garcia, Sarriguren (ES)

(73) Assignee: ABENGOA BIOENERGIA NUEVAS TECNOLOGIAS, S.A., Sevilla (ES)

(21) Appl. No.: 13/103,525

(22) Filed: May 9, 2011

(51) Int. Cl. H04N 7/18

(52) U.S. Cl. 348/144; 348/143; 348/E07.085

(57) ABSTRACT

Particularly applicable to the implementation of sustainability requirements concerning on the promotion of the use of bioproduct from renewable sources, through the system and method described is possible to ensure that the origin of raw materials is sustainable (according to a previously defined sustainability requirements), avoiding travel to the area of interest, thus saving time and economic costs and preventing errors and fraud. More specifically, the system and method object of the invention are particularly applicable for identifying those areas that comply with said sustainability requirements. Said sustainability requirements state that raw material intended for bioproduct production shall not be made from lands with a high biodiversity, high carbon stock or peatlands, and bearing in mind additionally the land use requirement.

### OBJECT OF THE INVENTION

The present invention relates to the field of recognition and presentation of data and images, and more specifically to arrangements and methods for identifying regions with sustainable characteristics using remote sensing techniques.

The main object of the invention is a system and a method for identifying sustainable geographical areas for the production of raw materials intended for bioproduct production by remote sensing techniques.

### BACKGROUND OF THE INVENTION

At present, it is well known that the global climate is being altered significantly as a result of increased concentrations of greenhouse gases such as carbon dioxide, methane, nitrous oxides and chlorofluorocarbons. These gases are trapping an increasing proportion of terrestrial infrared radiation and are expected to increase global temperatures (so-called Greenhouse Effect and Global Warming). That is why the enormous importance that are currently taking all initiatives for the use of bioproducts, and more particularly biofuels. It should be noted that the term “bioproducts” include building materials, pulp and paper, forest products, biofuels, bioenergy, starch-based and cellulose-based ethanol, biochemicals, bioplastics, etc.

Bioproducts are active subjects of research and development, and these efforts have developed significantly since the turn of the 20/21st century, mainly driven by the environmental impact of petroleum use. Bioproducts derived from bioresources can replace much of the fuels, chemicals, plastics etc. that are currently derived from petroleum. For example bioenergy is sort of bioproduct which provides a renewable energy source made available from materials derived from biological sources.

Said bioproduct used as a real alternative must be sustainable. To obtain sustainable bioproduct, it must ensure that the origin of raw materials is sustainable, but the checking in-situ is very difficult.

Likewise it is important to define remote sensing as a “technique which provides remote information from the objects in the Earth's surface or phenomena that take place thereof. For this remote observation there must be some kind of interaction between the objects and the sensor”. (Chuvieco, “Fundamentals of satellite remote sensing”, 1996). Currently it is well known the use of satellite images for displaying different phenomena produced, for example: population growth, urban planning, rural planning, etc.

The following describes an example of sustainability requirements that could be requested to the raw material (biodiversity requirement, carbon stock requirement, and peatland requirement):

### 1—Biodiversity Requirement:

1a) Primary forest and other (primary) wooded land, namely forest and other wooded land of native species, where there is no clearly visible indication of human activity and the ecological processes are not significantly disturbed.

1b) Nature Protection Areas:
Areas designated by law or by the relevant competent authorities for nature protection purposes; or,
For the protection of rare, threatened or endangered ecosystems or species recognized by international agreements, or included in lists drawn up by intergovernmental organizations or the International Union for Conservation of Nature (IUCN).

1c) Highly Biodiverse Grassland:
Natural: namely grassland that would remain grassland in the absence of human intervention and which maintains the natural species composition and ecological characteristics and processes; or
Non natural: namely grassland that would cease to be grassland in the absence of human intervention and which is species-rich and not degraded.

### Exceptions:

Nature protection areas: evidence is provided that raw material production does not interfere with nature protection purposes.

### 2—Carbon Stock Requirement:

2a) Wetlands: namely land that is covered with or saturated by water permanently or for a significant part of the year.

2b) Continuously forested areas namely land spanning more than one hectare with trees higher than five meters and canopy cover of more than 30% or trees able to reach those thresholds in situ. It does not include land that is predominantly under agricultural or urban land use.

2c) Lands spanning more than one hectare with trees higher than five meters and a canopy cover between a given range, or trees able to reach those thresholds in situ, unless evidence is provided.

### Exceptions:

The provisions of this paragraph shall not apply if, at the time when the raw material was obtained, the land had the same status it had in a specific earlier date.

### 3—Peatland Requirement:

Raw material intended for bioproduct production shall not be made from land that was peatland in a specific earlier date.

### Exceptions:

Evidence is provided that the production and harvesting of that raw material does not involve drainage of previously undrained soil.

Evidence is provided that the soil was completely drained in a particular year.

Evidence is provided that there has been no draining of the soil since a particular earlier date.

### 4—Land Use Change Requirement (LUC Requirement):

It refers to the need of minimizing emissions of greenhouse gases caused by changes in land use since a particular year. Land use change should be understood as referring to changes in terms of land cover between the six land categories used by the IPCC (forest land, grassland, cropland, wetland, settlements and other land) plus a seventh category of perennial crop.

### Exceptions:

A change from one crop to another is not considered land use change.

Cropland includes fallow land (land left at rest for one or several years before being cultivated again).

A change of management activities, tillage practice or manure input practice is not considered land use change

The technical problem posed here is to provide a system and a method for the detection, recognition and location of those potential areas or regions that could be used for the production of raw materials intended for bioproduct production, ensuring that the origin of raw materials is sustainable and avoiding travel to the area of interest, thus saving time and economic costs, and preventing errors and fraud.

### DESCRIPTION OF THE INVENTION

The present invention resolves the aforementioned drawbacks by providing a system and a method for identifying sustainable geographical areas for the production of raw materials intended for bioproduct production by remote sensing techniques. More specifically, the system and method object of the invention are particularly applicable for identifying those areas that comply with previously defined sustainability requirements. Said sustainability requirements state that raw material intended for bioproduct production shall not be made from lands with a high biodiversity, high carbon stock or peatlands, and bearing in mind additionally the land use requirement cited above.

Next, some definitions corresponding to some terms which will be used below are provided:

Go area: is a region that complies with established sustainability requirements for biodiversity, carbon stock and peatland.

Partial Go area: is a region that complies with the established sustainability requirements for biodiversity (except for nature protection areas), carbon stock and peatland.

Origin: is the geographical denomination that stands for the production and harvesting zone of the raw material to be further processed into bioproduct.

Sustainable origin: is the origin of the raw material which is deemed to comply with the established sustainability requirements for biodiversity, carbon stock, peatland and land use change.

The system for identifying sustainable geographical areas object of the present invention comprises:
identification means of sustainability requirements referring to land use and nature protection areas,
at least one imaging system adapted to capture images of the geographical areas wherein said at least one imaging system is furnished with image transmission means for transmitting the captured images,
at least one data base accessible by the imaging system adapted to allocate at least images,
at least one historical database comprising historical images of the geographical areas and accessible by the processing unit,
at least one processing unit at least connected to the databases and adapted to retrieve and process the images captured by the imaging system by means of an image processing module and the historical images, and
storage means accessible by the processing unit.

Preferably said system for identifying sustainable geographical areas further comprising output means linked to the processing unit and adapted to display information related to the geographical areas. Said imaging system preferably comprises at least one sensor selected from the group consisting of: low resolution sensors, medium resolution sensors and high resolution sensors.

Likewise, preferably, at least one database further comprises historical images of geographical areas.

At least one database comprises auxiliary data comprising:
cartographic data comprising supporting data for the process of orthorectification of images,
thematic data comprising supporting data for the land use analysis, and
biodiversity data comprising supporting data for the identification of nature protection areas.

On the other hand at least one database is allocated at a server or at the storage means, accessible by the processing unit.

According to another object of the invention, the method for identifying sustainable geographical areas, object of this invention, basically stands out for comprising the following steps:

a) preliminary preparation which comprises the steps of:
identification of sustainability requirements,
association of figures,
identification of the studied region,
   b) information capture, which comprises the following steps:

b1) satellite images capture for the studied region, in low or medium/high resolution, from the at least one imaging system and a database of historical archives of images available in official data bases,
b2) auxiliary data selection used to facilitate analysis of land use cover, or as baseline layer of the studied region, for example, to evaluate biodiversity referring to protected areas,
   c) land use analysis, which comprises the following steps:
c1) satellite images import into the image processing module,
c2) images preprocessing in low or medium/high resolution for images conditioning, in order to obtain a land use classification distinguishing the figures defined by sustainability requirements in one map, and the six categories used by IPCC plus a seventh category of perennial crops in another map,
c3) image classification in order to obtain the land use classification, identifying the land cover for each area.
   d) information processing, which comprises the following steps:
d1) information processing for identifying land uses,
d2) information processing for identified protected figures,
d3) comparing the processed information in order to determine land use matching and non matching areas,
   e) analysis process by documentary evidence, and
   f) displaying the results.

This method provides information that allows demonstrating fulfillment of the land use requirements (high biodiversity, high carbon stock and peatland) in the studied areas and the land use change in accordance with the six categories used by IPCC plus a seventh category (perennial crop) in the studied areas.

The aim of this method is to identify:

Areas that comply with sustainability requirements, hereinafter “Go Areas”.

Regions without land use change.

The method object of the invention complies with the following conditions:

Uniformity and homogeneity: the process must be easily applied in any other region and any other temporal range, obtaining comparable results. In order to be able to implement the method in new regions or temporal periods if necessary.

Use of methodological standards proven and characterized by effectiveness in the process.

Additionally, the present method provides maps using graphic evidence, complementing part of the information with documentary evidence where required. The process comprises two main stages:
Preliminary preparation, where the sustainability requirements are identified.
Map development process where the data (satellite images, or complementary maps among others) are initially captured, and the data are then analyzed, obtaining maps with land use information compiled according to land use criteria. Two differentiated information processing procedures are carried out on the analyzed data: on the one hand processing for land use figures and, on the other hand, a specific processing for protected figures.

The information processing is compared, preferably polygon by polygon, or pixel by pixel, among others, for each area in two reference dates (the initial reference year and the final reference year). The following is obtained as results from this process:

One Go area map, and

Map to identify land use change.

In the Go areas map, all studied regions accomplish with the sustainability requirements. In parallel, the land use change map, all studied regions must be compiled in a map where the changes of categories are identified by region.

Those coincident regions to NUT 3 or lower level (or their correspondence in GAUL or other administrative unit), which comply with sustainability requirements and do not have land use change are included in the sustainable origins list. It should be noted that “NUT” and “GAUL” are territorial systems of geographical division.

Some preferred aspects relating the steps a) to f) are explained in higher detail below.

### a) Preliminary Preparation:

The preliminary preparation comprises the following tasks:

a1) Identification of sustainability requirements,

a2) Association of figures, and

a3) Identification of the studied region.

a1) Identification of land use requirements,
a2) The figures are grouped by type of requirement to be compiled, in order to ease the later processing process. It differentiates:

Figures referring to land use such as:

Categories established in the biodiversity requirement: primary forest, other (primary) wooded land, and grassland. In the case of grassland no differentiation is made between natural and non natural, because both of them are excluded. This scheme does not allow raw material obtained from any kind of grassland.

Categories shown in the carbon stock requirement: wetland, continuously forested areas with a specific range of canopy cover. Preferably the range of canopy cover is more than 30% or between 10% and 30%.

Categories shown in the peatland requirement.

Land use categories used by IPCC plus the category of perennial crop, in order to comply with GHG requirements.
Figures referring to nature protection areas designed by law or international agreements, intergovernmental organizations or the International Union for Conservation of Nature (IUCN) in reference to Biodiversity requirement. The present scheme considers Natura 2000, IUCN classification and national nature protection areas not contemplated in the above figures.
   a3) The studied region is identified as an external input to a NUT 3 or lower level (or its correspondence in GAUL) in EU-27 and a similar division to NUT 3 or lower level (or its correspondence GAUL) outside EU-27. This is the starting point of the process, and suitable records are kept.
   b) Information capture, review and verification of data:
   This step is undertaken in order to:
compile all necessary information from available data sources to execute the project in each studied region.
select only the suitable sources to cover project requirements.
acquire or download the selected data
undertake quality controls.
   b1) According to a preferred embodiment of the invention, the satellite images captured are obtained (for instance, purchased) from available sources.

Satellite images are selected to obtain a whole cover of each studied area and to represent the land use types on reference dates, initial and final date (map generation date). The selected images must be chosen considering that the combination of spatial, spectral and radiometric resolution is the best suitable in order to demonstrate sustainability requirements and quality requirements.

The satellite images are differentiated in accordance with resolution and temporal availability:

Low resolution images must be downloaded for the initial reference date and the final reference date (comparative date), in order to guarantee the maximum temporal cover.

Medium/high resolution images must be downloaded for two representative dates, the initial reference date and the final reference date (comparative date).

The image selection between low and medium/high resolution is taken in order to cover the sustainability requirements with the best quality as possible. Multi-temporal analyses of image makes it possible to represent the seasonal variation in land use cover in the best possible way, mainly reducing cloudy, foggy, shadow or cover impact. Finally, the image must be downloaded and subjected to quality validation, fulfilling the data quality. Data validation records should be kept. The results of the analysis process must be shown in a report and downloaded images must be stored in a database.

b2) A selection of auxiliary data and images is required to make an extensive compilation of information. Preferably, the auxiliary data is selected from geographic databases belonging to official sources such as official organizations or authorized governmental agencies on the relevant matter, said auxiliary data comprising:
cartographic data comprising supporting data for the process of orthorectification of images,
thematic data comprising supporting data for the land use analysis, and
biodiversity data comprising supporting data for the identification of nature protection areas.

This auxiliary data is used as support to facilitate analysis of land use cover, or as baseline layer. For example, to evaluate biodiversity referring to protected areas.

In the case of protected areas, the auxiliary information compiled for biodiversity is used directly from official databases, except for the necessary processing in order for it to be compatible with the resulting information processing map for land use figures. As the final result of the auxiliary data selection for nature protection areas, a map is obtained with the protected figures.

### c) Land Use Analysis:

In this stage the images are analyzed and classified through a standardized process, explained as follows. The same process must be performed for the initial reference year and the comparative final reference year.
c1) Satellite images captured are imported into a digital image processing software. There are two types of resolution:
Low resolution data, and
Medium/high resolution data.
   c2) Images are preprocessed in low or medium/high resolution for images conditioning:

Low resolution data load, mosaic and reprojection. In order to cover the total surface of the studied region, a mosaic of scenes must be produced with all images downloaded for each date. Firstly the downloaded image in original format must be imported to the digital image processing software. In this way the geometric references would not be lost and integration with other data sources is possible. In the mosaic process, the low resolution images are projected in the coordinates of a common reference geographic system.

Medium/high resolution data load and orthorectification. In this case, the medium/high resolution images is imported to the digital image processing software, and it is orthorectified with necessary auxiliary data that makes it possible to guarantee appropriate accuracy in the results. Preferably the orthorectification process comprises the following steps:
tie points measurement,
calculation and application of a mathematical geometric model, and
calculation of the geometric error.
   c3) Image Classification:
   The final result is to obtain the following for both years (initial and final):

A land use classification distinguishing the figures defined by sustainability requirements in one map and,

The six categories used by IPCC plus a seventh category of perennial crops in another map.

The image classification is performed in order to obtain the land use classification, identifying the land cover for each area. Preferably, this step c3 further comprises classifying images in order to obtain land uses of forested areas with canopy cover between 10 and 30%.

A standard classification is used for the image classification considering the differentiated covers. Image classification is the process that identifies the different spectral classes of each image and it is associated in generic categories. On this resultant product it is necessary to analyze the cover type. Likewise, auxiliary data is used for the image classification such as baseline, which makes it possible to identify large covers such as water masses or urban areas, among others.
Aggregation and Exportation:
   Once the image classification process has been finished, an analysis of the cover type and the seasonality is made in order to aggregate, depending on the categories required, the figures defined by sustainability requirements on the one hand and on the other hand the categories used by IPCC, plus a seventh category of perennial crop.

The aggregation in accordance with categories defined by sustainability requirements is repeated for the initial reference year and the final reference year. A comparative analysis is to be made in both aggregations of land use. The comparative analysis between the two reference years for the aggregation is made in the same way depending on the six categories used by IPCC plus a seventh category of perennial crop. The results could be exported in the most convenient image format in order to upload them in Geographic Information Systems (GIS) software.

### d) Information Processing:

d1) Information processing for identifying land uses (comparative).
The results obtained are preferably shown in two maps representing the land use classification of figures, and two maps depicting the land use classification of the six categories used by IPCC plus a seventh category of perennial crop, corresponding to the initial reference year and the final reference year. The comparative analysis on land use evolution in the selected region can preferably be made using these maps. The analysis of land use evolution may preferably be determined by processing a cover percentage for each selected polygon/pixel of each land use category. The analysis will be made for all the polygons/pixels determined in the entire studied areas. This process will allow determining if a change of category has been produced for each area.

The result of the comparative analysis for land use change maps is preferably a map establishing the regions with category change or without category change. In parallel, the result of the comparative analysis for sustainability requirements study is a partial result, identifying the partial Go areas. This result of comparative analysis can be positive or negative.

Positive result: this result could be obtained in two cases when,

All land use categories of the entire studied area are maintained from the initial reference date to the final reference date; in consequence, a change of typology has not occurred, or

A change of typology has occurred but the cover of land use categories required by sustainability requirements has increased (assessing each land use category polygon by polygon) or cropland has decreased (assessing cropland category polygon by polygon) from the initial reference date to the reference final date.

In both cases of positive result the requirements comply with sustainability requirements. In consequence partial Go area will be obtained.

Negative result: this result could be obtained when a change of category has occurred; the cover of land use figures required by sustainability requirements decreased or cropland increased from the initial reference date to final reference date. The result of this comparative will be no-Go area. If the comparison has a negative result, an analysis process of documentary evidence must be opened. If this analysis has a negative result it will be considered no-Go area definitively and if the analysis result is a positive result supported with reliable documentary evidence, the comparative result will be considered a partial Go area.

d2) Information processing for protected figures (biodiversity)
The information selected for protected figures in the information capture process must be matched up in order to complete the analysis of protected figures on the results obtained in the information processing for land use figures. The protected figure information must represent the areas designated by law, authorities for nature protection purposes, intergovernmental organizations, IUCN or international agreements.
d3) Comparing the processed information in order to determine land use matching and non matching areas.
Preferably this step d3 is carried out identifying those lands classified according to sustainability requirements above mentioned. Once nature protection areas are matched up, the result of analysis may match or not with land use figures into partial Go area:

If a protected figure matches with land use figures into partial Go area: the region complies with sustainability requirements, in consequence the region is a Go area.

If a protected figure does not match (totally or partially) with land use figure into partial Go area: an analysis process for documentary evidence must be opened. If the result of this analysis is that the area is not compatible with the production of raw materials, the area will be considered a non-sustainable origin. In contrast, if the analysis result is that the area is compatible with the production of raw materials, the area will be considered a Go area.

Those regions classified as Go areas and without land use change in the LUC map will be included in the sustainable origin list, and no further evidence is needed for the production of raw materials in the origin than to demonstrate proper origin and consistency of quantities produced through Mass Balance System requirements.

This final information shall include suitable codes for geographical demarcation, in order to facilitate its further use throughout the implementation of the scheme, the verification process and also the maps themselves.

### e) Documentary Evidence:

In those cases where graphic evidence is not enough to demonstrate fulfillment of sustainability requirements, an analysis of documentary evidence will be made, which consists of the compilation of complementary information that makes it possible to demonstrate the fulfillment of sustainability requirements through an exhaustive study of a specific area (NUT 3 or lower level or in its correspondence in GAUL or other administrative unit) considering:

Official statement from an official organization or authorized governmental agency on the relevant matter, on some or all the sustainability criteria.

Official databases that compile information on specific figures required by sustainability requirements or that can demonstrate that the surface cover by land use figures required by sustainability requirements have maintained a positive trend in the studied region from the initial reference year to the year of study. In the event that data are not available for the initial reference year, historic data will be used to calculate a trend line. Only in the case that each sustainability criteria required by sustainability requirements can be positively demonstrated with at least one or several reliable pieces of evidence from the above list would the studied region be considered a sustainable origin. Records of each piece of documentary evidence must be maintained, complying with updating requirement.

### f) Displaying the Results:

Preferably, the results are displayed through a sustainable origin list or a map representing suitable origins for the production of raw materials intended for bioproduct production.

According to another object of the invention it is described a software application that includes final results of method above described, showing said results in a list or in a map comprising sustainable origins.

Additionally, the results obtained are used to select potential sources of purchase in order to obtain raw material used to produce bioproduct.

### DESCRIPTION OF THE DRAWINGS

In order to complement this description and with the object of helping to better understand the characteristics of the invention, a set of drawings, in accordance with a preferred example of practical embodiment thereof, has been included as an integral part of said description, wherein the following has been represented in an illustrative and non-limiting manner:

FIG. 1.—Shows the result of sustainable areas obtained according to a preferred embodiment of the invention.

FIG. 2.—Shows a flowchart of map development process of the method object of the invention.

### PREFERRED EMBODIMENT OF THE INVENTION

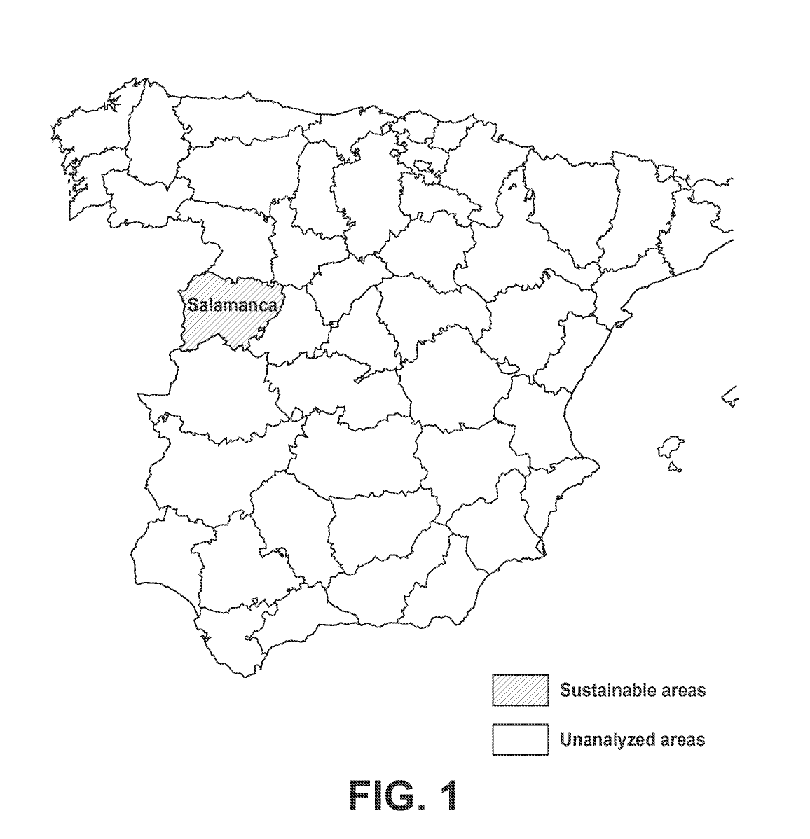

According to a preferred embodiment, the satellite images capture is carried out by IRS-P6 satellite over the study region of Salamanca (Spain), as shown in FIG. 1. Said IRS-P6 incorporates LISS-III sensor adapted to capture images of 20 m spatial resolution in 4 spectrum bands (red, green, NIR, SWIR), and AWIFS sensor, whose images comprise a spatial resolution of 60 m in the same bands that the LISS-III sensor. The medium resolution images selected in the present embodiment are:

| Satellite | Sensor | Pixel | Acquisition | GAUL2 |
|---|---|---|---|---|
| IRS-P6 | AWIFS | 60 m | Summer | Salamanca |
| IRS-P6 | AWIFS | 60 m | Summer | Salamanca |
| IRS-P6 | AWIFS | 60 m | Autumn | Salamanca |
| IRS-P6 | AWIFS | 60 m | Winter | Salamanca |
| IRS-P6 | AWIFS | 60 m | Summer | Salamanca |
| IRS-P6 | LISS_III | 20 m | Spring | Salamanca |
| IRS-P6 | LISS_III | 20 m | Spring | Salamanca |
| IRS-P6 | LISS_III | 20 m | Autumn | Salamanca |
| IRS-P6 | LISS_III | 20 m | Autumn | Salamanca |

Additionally, the auxiliary data selected in order to facilitate analysis of land use cover, is:

### a) Cartographic Auxiliary Data:

Digital Elevation Model (DEM)

Basic cartographic information from Spain.

The orthorectification of the medium-resolution images is carried out with the support of basic cartographic information from Spain and Digital Elevation Model, in order to eliminate the geometric distortions due mainly to relief, the curvature of the earth's surface and the geometry of image acquisition. For the present embodiment It is selected DEM from ASTER satellite which is free access.

Basic cartographic information from Spain, provided by National Center for geographic information, includes limits of the regions, provinces and towns from the digital cartographic base BCN50.

### b) Thematic Auxiliary Data:

CORINE Land Cover 2006

Statistics uses and land cover

Landsat 7 ETM Base

It is selected CORINE Land Cover 2006 (Coordination of Information on the Environment). It is a land uses map at European level. This map represents the territory according to 44 classes of land use, grouped into 5 levels. Level 3 is the highest level of detail that reaches the CORINE classification for the entire European

### c) Biodiversity Data:

Protected areas and areas recognized by the International Union for Conservation of Nature (IUCN)

Natura network 2000

Primary Forests.

The fulfillment of the sustainability requirements should be demonstrated with external proof, such as graphic evidence through technological solutions and documentary evidence. The reference dates of the evidence used by the present scheme are detailed in the next table:

| Requirement | Restrictions | Initial date | Final date |
|---|---|---|---|
| Biodiversity | Primary forest and other | 2008 | 2009 |
| | (primary) wooded land | | |
| | Nature protections areas | | |
| | High biodiverse grassland | | |
| Carbon stock | Wetland | 2008 | 2009 |
| | Forested areas | | |
| Peatland | Peatland | 2008 | 2009 |
| Land use | Change between land use | 2008 | 2009 |
| change | categories | | |

The evidence admitted for this scheme has the following formats:

Graphic evidence.

Documentary evidence such as Official statements, legislation or official databases.

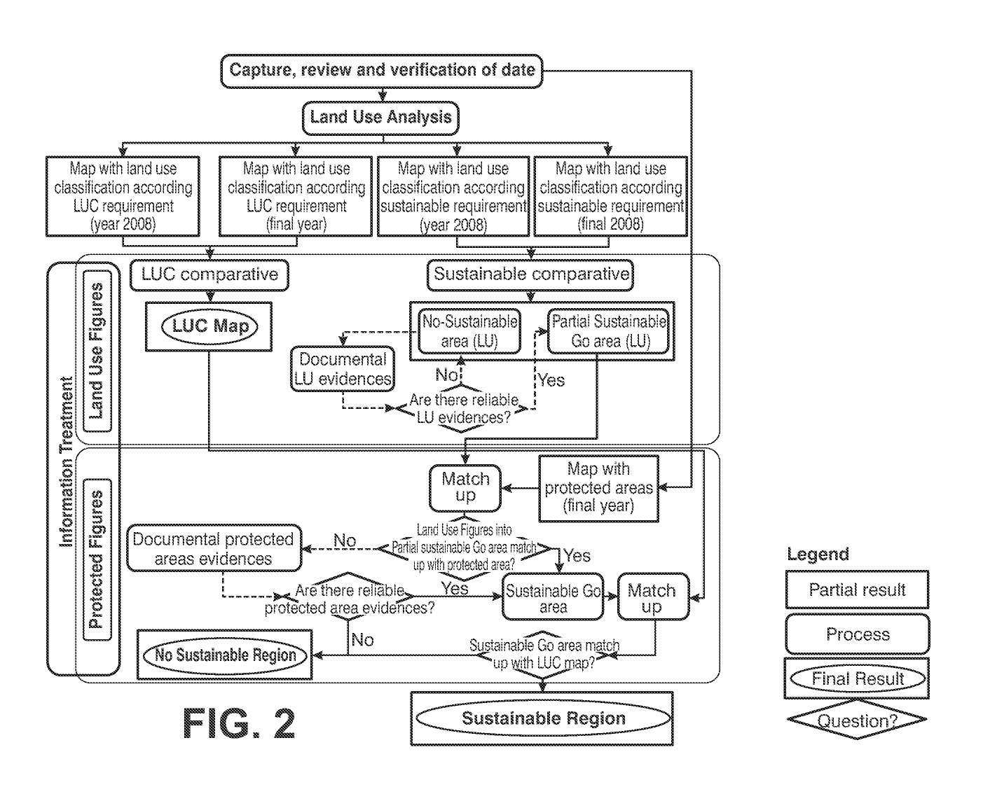

As shown in the flowchart of FIG. 2, the method for identifying sustainable geographical areas, object of the present invention, comprises the following steps:

a) preliminary preparation which comprises the steps of:
identification of sustainability requirements,
association of figures,
identification of the studied region,
   b) information capture, which comprises the following steps:
b1) satellite images capture for the studied region, in medium/high resolution, from the IRS-P6 satellite and a database of historical archives of images available in official data bases,
b2) auxiliary data selection used to facilitate analysis of land use cover, or as baseline layer of the studied region, for example, to evaluate biodiversity referring to protected areas,
   c) land use analysis, which comprises the following steps:
c1) satellite images import into a digital image processing software, and
c2) images preprocessing in medium/high resolution for images conditioning, in order to obtain the land uses of the studied region represented in satellite images captured,
c3) image classification in order to obtain the land use classification, identifying the land cover for each area,
   d) information processing, which comprises the following steps:
d1) information processing for identifying land uses,
d2) information processing for identified protected figures,
d3) comparing the processed information in order to determine land use matching and non matching areas,
   e) analysis process by documentary evidence, and
   f) displaying the results.

Finally, after application of the present method for identifying sustainable areas, it is considered that Salamanca is a sustainable origin for the production of raw materials intended for bioproduct production.

1. System for identifying sustainable geographical areas by remote sensing techniques characterised by comprising:
identification means of sustainability requirements referring to land use and nature protection areas,
at least one imaging system adapted to capture images of the geographical areas wherein said at least one imaging system is furnished with image transmission means for transmitting the captured images,
at least one data base accessible by the imaging system adapted to allocate at least images,
at least one historical database comprising historical images of the geographical areas and accessible by the processing unit,
at least one processing unit at least connected to the databases and adapted to retrieve and process the images captured by the imaging system by means of an image processing module and the historical images, and
storage means accessible by the processing unit.

2. System according to claim 1 characterised by further comprising output means linked to the processing unit and adapted to display information related to the geographical areas

3. System according to claim 1 wherein the imaging system comprises at least one sensor adapted to capture images with spatial resolution in spectrum bands.

4. System according to claim 3 wherein the at least one sensor is selected from the group consisting of: low resolution sensors, medium resolution sensors and high resolution sensors.

5. System according to claim 1 wherein the at least one database further comprises auxiliary data comprising:
cartographic data comprising supporting data for the process of orthorectification of images,
thematic data comprising supporting data for the land use analysis, and
biodiversity data comprising supporting data for the identification of nature protection areas.

6. System as in one of claims 1 to 5 wherein the at least one database is allocated at a server accessible by the processing unit.

7. System as in one of claims 1 to 5 wherein the at least one database is allocated at the storage means.

8. Method for identifying sustainable geographical areas by remote sensing techniques using the system of claim 1 comprising the following steps:
a) preliminary preparation which comprises the steps of:
identification of sustainability requirements,
association of figures,
identification of the studied region,
b) information capture, which comprises the following steps:
b1) satellite images capture for the studied region, in low or medium/high resolution, from an imaging system and a database of historical archives of images available in official data bases,
b2) auxiliary data selection used to facilitate analysis of land use cover, or as baseline layer of the studied region,
c) land use analysis, which comprises the following steps:
c1) satellite images import into the image processing module,
c2) images preprocessing in low or medium/high resolution for images conditioning, in order to obtain the land uses of the studied region represented in satellite images captured,
c3) image classification in order to obtain the land use classification, identifying the land cover for each area,
d) information processing, which comprises the following steps:
d1) information processing for identifying land uses,
d2) information processing for identified protected figures,
d3) comparing the processed information in order to determine land use matching and non matching areas,
e) analysis process by documentary evidence, and
f) displaying the results.

9. The method according to claim 8, wherein the results are displayed through a list comprising sustainable origins.

10. The method according to claim 8, wherein the results are displayed through a map representing sustainable origins.

11. The method according to claim 8, wherein the auxiliary data selection comprises:
cartographic auxiliary data,
thematic auxiliary data, and
biodiversity data.

12. The method according to claim 8, wherein the auxiliary data is selected from geographic databases belonging to official sources such as official organizations or authorized governmental agencies on the relevant matter.

13. The method according to claim 8, wherein the images preprocessing in low resolution comprises the following steps:
reprojection, resampling, subsetting, mosaic processing and bands extraction,
mask generation for the elimination of low quality pixels,
multidate image generation, and
synthetic bands generation and incorporation of digital elevation model (DEM).

14. The method according to claim 8, wherein the images preprocessing in medium/high resolution comprises:
orthorectification process,
mosaic process,
images resampling, and
image cutting of the studied region.

15. The method according to claim 8, wherein the step c3) further comprises classifying images in order to obtain land uses of forested areas with canopy cover between a specific range.

16. The method according to claim 15, wherein the range of canopy cover is between 10 and 30%.

17. The method according to claim 8, wherein the results obtained in the step d1) are shown in:
two maps representing the land use classification of figures, and
two maps depicting the land use classification of the six categories used by IPCC plus a seventh category of perennial crop, corresponding to the initial reference year and the final reference year.

18. The method according to claim 8, wherein the analysis of land use evolution of the step d1) is determined by processing a cover percentage for each selected polygon/pixel of each land use category.

19. The method according to claim 8, wherein the information selected for protected figures in the information capture process of the step d2) is matched up in order to complete the analysis of protected figures on the results obtained in the information processing for land use figures.

20. The method according to claim 8, wherein the step d3) of determining land use matching and non matching areas is carried out identifying those lands classified according to sustainability requirements.

21. The method according to claim 8, wherein the results obtained are used to select potential sources of purchase in order to obtain raw material used to produce sustainable bioproduct.

22. Software application that includes final results of the method of claim 8, and shows said results in a list or in a map comprising sustainable origins.
